(19) United States
(12) Patent Application Publication
(10) Pub. No.: US 2008/0310261 A1
(43) Pub. Date: Dec. 18, 2008

(54) OPTICAL PICKUP AND OPTICAL DISK APPARATUS

(75) Inventor: Masaharu Sakata, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/136,323

(22) Filed: Jun. 10, 2008

(30) Foreign Application Priority Data
Jun. 13, 2007 (JP) 2007-155904

(51) Int. Cl. G11B 7/00

(52) U.S. Cl. 369/44.15

(57) ABSTRACT

An optical pickup includes: a base; a lens holder that is provided on the base to hold an objective lens which collects a light beam emitted from a light source and applies it onto an optical disk; a supporting plate that is provided on the base and spaced from the lens holder in a direction orthogonal to a focusing direction in parallel with a plane including the focusing direction and a tracking direction; and a plurality of suspension wires that is provided over the lens holder and the supporting plate to movably support the lens holder in the focusing direction and the tracking direction with respect to the supporting plate. The supporting plate has flexibility. A damping member is provided on the mounting plate. When the supporting plate is bent in the longitudinal direction of the suspension wire, the damping member is deformed to absorb vibrations of the lens holder.

### CROSS REFERENCES TO RELATED APPLICATIONS

The present invention contains subject matter related to Japanese Patent Application JP 2007-155904 filed in the Japanese Patent Office on Jun. 13, 2007, the entire contents of which being incorporated herein by reference.

### BACKGROUND OF THE INVENTION

1. Field of the Invention

The present invention relates to an optical pickup that records and reproduces signals on an optical disk and an optical disk apparatus that has such an optical pickup.

2. Description of the Related Art

There is an optical pickup that records or reproduces, or records and reproduces signals on an optical disk such as a DVD (Digital Versatile Disk) by applying a light beam onto the optical disk.

Heretofore, an optical pickup has a lens holder that holds an objective lens which collects a light beam emitted from a light source and applies it onto an optical disk, in which the lens holder is coupled to a rigid support through a suspension wire, whereby the lens holder is movably supported with respect to the support in the focusing direction and the tracking direction.

As discussed above, in the structure in which the lens holder is supported through the suspension wire, because of the mechanical characteristics of the suspension wire, undesired resonance tends to occur in the lens holder, which is disadvantageous to intend to stabilize servo control.

On this account, such an optical pickup is proposed in which a printed wiring board with elasticity is mounted on a support, and the end part of a suspension wire is soldered to the printed wiring board to vibrate the printed wiring board together with the suspension wire, as well as a through hole for resonance frequency band control is formed on the printed wiring board to provide the printed wiring board with a function that damps vibrations, whereby undesired resonance that occurs in a lens holder is suppressed (see Patent Reference 1 (JP-A-H08-263860)).

### SUMMARY OF THE INVENTION

In recent years, for an optical pickup that uses two light beams with different wavelengths for recording and/or reproducing signals on an optical disk, such an optical pickup is proposed that two objective lenses corresponding to two light beams are assembled in a single lens holder.

As discussed above, in the structure in which two objective lenses are assembled in a single lens holder, the distance between the optical axis of the objective lens and the center of vibrations of the lens holder tends to become long. Thus, a great problem arises that undesired resonance that occurs in the lens holder affects the optical characteristics of the optical pickup. It is necessary to effectively suppress undesired resonance of the lens holder and to intend to stabilize servo control.

It is desirable to provide an optical pickup and an optical disk apparatus which advantageously intend to stabilize servo control.

An embodiment of the invention is an optical pickup including: a base; a lens holder that is provided on the base to hold an objective lens which collects a light beam emitted from a light source and applies it onto an optical disk; a supporting plate that is provided on the base and spaced from the lens holder in a direction orthogonal to a focusing direction in parallel with a plane including the focusing direction and a tracking direction; and a plurality of suspension wires that is provided over the lens holder and the supporting plate to movably support the lens holder in the focusing direction and the tracking direction with respect to the supporting plate, wherein the supporting plate has flexibility, a damping member is provided on the mounting plate, and when the supporting plate is bent in the longitudinal direction of the suspension wire, the damping member is deformed to absorb vibrations of the lens holder.

In addition, another embodiment of the invention is an optical pickup including: a base; a lens holder that is provided on the base to hold an objective lens which collects a light beam emitted from a light source and applies it onto an optical disk; and a support mechanism that supports the lens holder, in which the support mechanism is configured to include a suspension wire that movably supports the lens holder on the base in a focusing direction and a tracking direction, wherein the lens holder is provided with a mounting plate with flexibility which is in parallel with a plane including the focusing direction and the tracking direction and to which an end part of the suspension wire is coupled, a damping member is provided on the mounting plate, and when the mounting plate is bent in the longitudinal direction of the suspension wire, the damping member is deformed to absorb vibrations of the lens holder.

In addition, another embodiment of the invention is an optical pickup including: abase; a lens holder that is provided on the base to hold an objective lens which collects a light beam emitted from a light source and applies it onto an optical disk; and a support mechanism for the lens holder, in which the support mechanism is configured to include a suspension wire that movably supports the lens holder on the base in a focusing direction and a tracking direction, wherein the support mechanism is configured to include a damping member that absorbs vibrations of the lens holder along the longitudinal direction of the suspension wire.

In addition, another embodiment of the invention is an optical disk apparatus including: a drive means for holding an optical disk to rotate and drive it; and an optical pickup that applies a light beam for recording and/or reproducing onto the optical disk rotated and driven by the drive means, and detects a light beam reflected from the optical disk, wherein the optical pickup includes: a base that is moved in a tracking direction of the optical disk, a lens holder that is provided on the base to hold an objective lens which collects a light beam emitted from a light source and applies it onto the optical disk, a supporting plate that is provided on the base and spaced from the lens holder in a direction orthogonal to a focusing direction in parallel with a plane including the focusing direction and the tracking direction, and a plurality of suspension wires that is provided over the lens holder and the supporting plate to movably support the lens holder in the focusing direction and the tracking direction with respect to the supporting plate, the supporting plate has flexibility, a damping member is provided on the mounting plate, and when the supporting plate is bent in the longitudinal direction of the suspension wire, the damping member is deformed to absorb vibrations of the lens holder.

In addition, another embodiment of the invention is an optical disk apparatus including: a drive means for holding an optical disk to rotate and drive it; and an optical pickup that applies a light beam for recording and/or reproducing onto the optical disk rotated and driven by the drive means, and detects a light beam reflected from the optical disk, wherein the optical pickup includes: a base that is moved in a tracking direction of the optical disk, a lens holder that is provided on the base to hold an objective lens which collects a light beam emitted from a light source and applies it onto the optical disk, and a support mechanism that supports the lens holder, in which the support mechanism is configured to include a suspension wire that movably supports the lens holder on the base in a focusing direction and the tracking direction, the lens holder is provided with a mounting plate with flexibility which is in parallel with a plane including the focusing direction and the tracking direction and to which an end part of the suspension wire is coupled, a damping member is provided on the mounting plate, and when the mounting plate is bent in the longitudinal direction of the suspension wire, the damping member is deformed to absorb vibrations of the lens holder.

In addition, another embodiment of the invention is an optical disk apparatus including: a drive means for holding an optical disk to rotate and drive it; and an optical pickup that applies a light beam for recording and/or reproducing onto the optical disk rotated and driven by the drive means, and detects a light beam reflected from the optical disk, wherein the optical pickup includes: a base that is moved in a tracking direction of the optical disk, a lens holder that is provided on the base to hold an objective lens which collects a light beam emitted from a light source and applies it onto the optical disk, and a support mechanism for the lens holder, the support mechanism is configured to include a suspension wire that movably supports the lens holder on the base in a focusing direction and the tracking direction, and the support mechanism is configured to include a damping member that absorbs vibrations of the lens holder.

According to the embodiments of the invention, since the supporting plate supports the suspension wires and the damping member is provided on the supporting plate, the damping member absorbs the vibrations of the lens holder. Therefore, the generation of undesired resonance of the lens holder can be effectively suppressed, which advantageously intends to stabilize servo control.

In addition, according to the embodiments of the invention, the lens holder is provided with the mounting plate to which the end part of the suspension wires is coupled, and the mounting plate is provided with flexibility, and the damping member is provided on the mounting plate. Thus, since the damping member absorbs the vibrations of the lens holder, the generation of undesired resonance of the lens holder can be effectively suppressed, which advantageously intends to stabilize servo control.

### BRIEF DESCRIPTION OF THE DRAWINGS

FIG. 1 shows a block diagram depicting the configuration of an optical disk apparatus 10 according to a first embodiment;

FIG. 2A shows a plan view depicting the configuration of an optical pickup 14 according to the first embodiment, and FIG. 2B shows a side view depicting the essential part of FIG. 2A;

FIG. 3 shows an illustration depicting the operation of a supporting plate 68 of the optical pickup 14 according to the first embodiment;

FIG. 4A shows a plan view depicting the configuration of an optical pickup 14 according to a second embodiment, and FIG. 4B shows a side view depicting the essential part of FIG. 4A;

FIG. 5A shows a plan view depicting the configuration of an optical pickup 14 according to a third embodiment, and FIG. 5B shows a side view depicting the essential part of FIG. 5A; and

FIG. 6A shows a plan view depicting the configuration of an optical pickup 14 according to a fourth embodiment, and FIG. 6B shows a side view depicting the essential part of FIG. 6A.

### DESCRIPTION OF PREFERRED EMBODIMENTS

### First Embodiment

Next, embodiments of the invention will be described.

First, an optical disk apparatus on which an optical pickup according to an embodiment of the invention is mounted will be described.

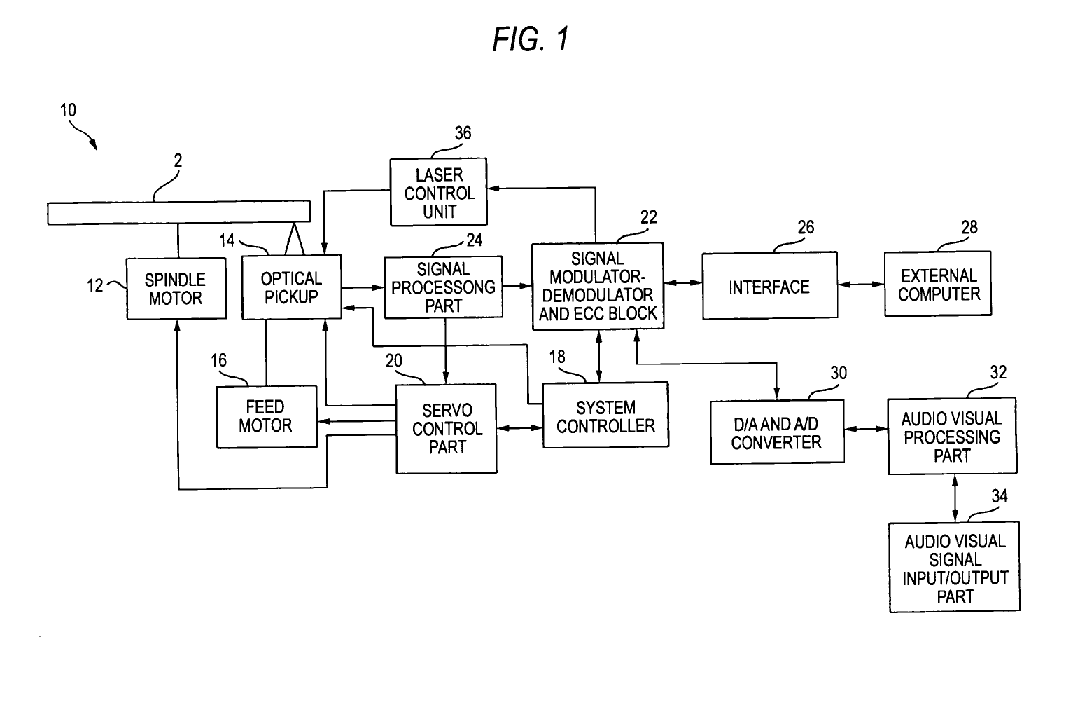

FIG. 1 shows a block diagram depicting the configuration of an optical disk apparatus 10 on which an optical pickup 14 according to a first embodiment is mounted.

As shown in FIG. 1, the optical disk apparatus 10 has a spindle motor 12 as a drive unit configured to drive an optical disk 2, the optical pickup 14, and a feed motor 16 as a drive unit configured to move the optical pickup 14 in the radial direction. Here, the spindle motor 12 is configured to be driven at a predetermined number of revolutions under control performed by a system controller 18 and a servo control part 20.

A signal modulator-demodulator and ECC block 22 modulates and demodulates signals outputted from a signal processing part 24 and adds ECC (error correcting code) to these signals. The optical pickup 14 applies a light beam onto the signal recording surface of the optical disk 2 rotated in accordance with instructions from the system controller 18 and the servo control part 20. A light beam is applied in this manner to record and reproduce optical signals on the optical disk 2.

In addition, the optical pickup 14 is configured to detect various light beams based on the light beam reflected from the signal recording surface of the optical disk 2, and to supply the signal corresponding to each of the light beams to the signal processing part 24.

In the embodiment, the optical pickup 14 is configured to record and/or reproduce signals on optical disks 2 with different wavelengths of the light beams for use, such as a DVD and a Blu-ray Disk.

The signal processing part 24 is configured to generate a servo control signal, that is, a focus error signal described later, a tracking error signal, an RF signal, a monitor signal (R-OPC signal) necessary for running OPC process, and an ATIP signal necessary for rotation control of an optical disk in recording, based on the detected signal corresponding to each of the light beams. In addition, depending on the type of recording medium to be a target for reproduction, a predetermined process such as demodulation and error correction processes based on these signals is performed by the servo control part 20 and the signal modulator-demodulator and ECC block 22.

Here, for example, in the casein which the recorded signals demodulated by the signal modulator-demodulator and ECC block 22 are used for data storage in a computer, these signals are sent to an external computer 28 through an interface 26. Thus, the external computer 28 is configured to receive the signals recorded on the optical disk 2 as reproduction signals.

In addition, in the case in which the recorded signals demodulated by the signal modulator-demodulator and ECC block 22 are audio visual signals, these signals are converted into analog signals in a D/A converting part of a D/A and A/D converter 30, and supplied to an audio visual processing part 32. Then, the signals are subjected to audio video signal processing in the audio visual processing part 32, and sent to an external imaging apparatus and an external projector through an audio visual signal input/output part 34.

The optical pickup 14 is configured in which the feed motor 16 is connected thereto, and the rotation of the feed motor 16 moves the optical pickup 14 to a predetermined recording track on the optical disk 2.

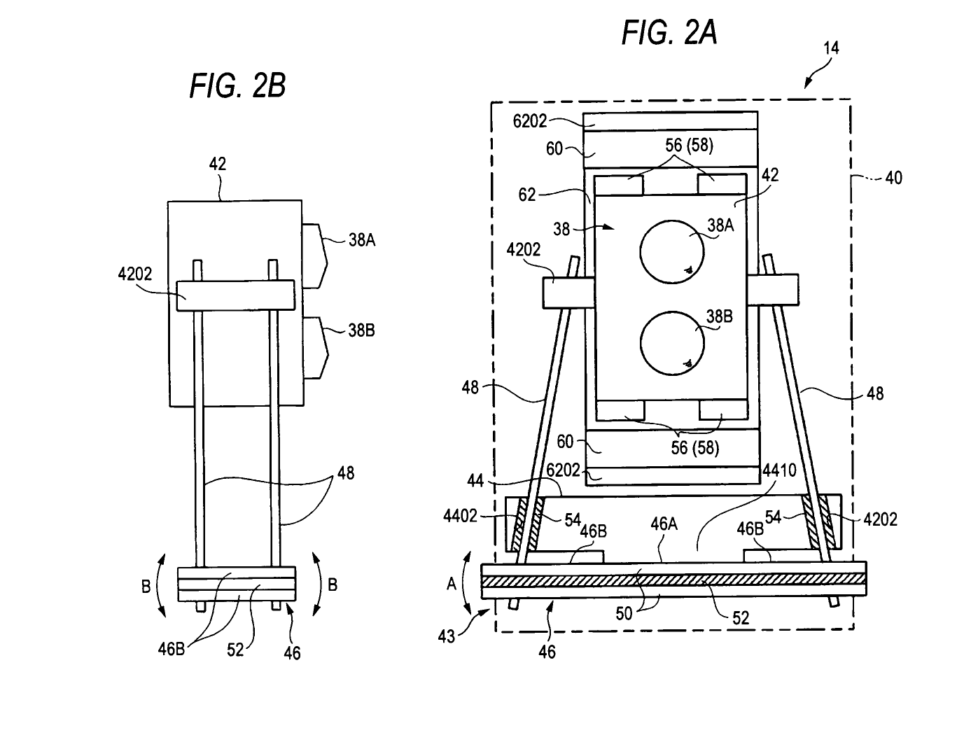

In addition to performing control over the feed motor 16 and the spindle motor 12, the servo control part 20 controls an objective lens 38 of the optical pickup 14 (FIG. 2A) in the focusing direction and the tracking direction based on the focus error signal and the tracking error signal, and also controls the radial skew.

In addition, a laser control part 36 controls a laser light source of the optical pickup 14, and controls both of first and second light sources, described later, in the embodiment.

Next, the optical pickup 14 according to the embodiment will be described.

FIG. 2A shows a plan view depicting the configuration of the optical pickup 14 according to the first embodiment, and FIG. 2B shows a side view depicting the essential part of FIG. 2A.

The optical pickup 14 has a semiconductor laser, not shown, as a light source that emits light, a photodiode, not shown, as an optical detecting device that detects the light beam reflected from the signal recording surface of the optical disk 2, and an optical system, not shown, that guides the light from the semiconductor laser to the optical disk 2 as well as guides the reflected light beam to the optical detecting device.

In the embodiment, the optical pickup 14 has the first and second light sources with different wavelengths, and optical detecting devices corresponding to the individual light sources.

The optical pickup 14 has a base 40, a lens holder 42, and a support mechanism 43 of the lens holder 42.

The support mechanism 43 is configured to include a support block 44, a supporting plate 46, and a plurality of suspension wires 48.

An actuator that moves the lens holder 42 is configured to include a focusing coil 56, a tracking coil 58, a magnet 60, and a yoke plate 62.

The base 40 is movably provided in the radial direction of the optical disk 2 by the feed motor 16, described above, inside a cabinet of the optical disk apparatus 10.

The lens holder 42 is provided on the base 40, having a rectangular plate shape with the width along the tracking direction, the height along the focusing direction, and the length along the tangential direction orthogonal to the tracking direction and the focusing direction.

The lens holder 42 has the objective lens 38 that collects the light beam emitted from the first and second light sources and applies it onto the optical disk 2. The objective lens 38 partially configures the optical system of the optical pickup 14.

In the embodiment, the objective lens 38 is configured of two objective lenses, a first objective lens 38A that collects the light beam from the first light source and a second objective lens 38B that collects the light beam from the second light source, in which the first and second objective lenses 38A and 38B are spaced in the direction orthogonal to the focusing direction (in the tangential direction, that is, in the length direction of the lens holder 42).

The supporting plate 46 is provided on the base 40 and spaced from the lens holder 42 in the direction orthogonal to the focusing direction, and the supporting plate 46 is in parallel with the plane including the focusing direction and the tracking direction.

Then, the suspension wire 48 is provided over the lens holder 42 and the supporting plate 46, which movably supports the lens holder 42 in the focusing direction and the tracking direction with respect to the supporting plate 46.

Since the suspension wire 48 is extended in the tangential direction, it can be said that the lens holder 42 has the length along the longitudinal direction of the suspension wire 48 and the width in the direction orthogonal to the length.

In the embodiment, the suspension wire 48 is configured of a material having conductivity and elasticity, and provided from the lens holder 42 to the supporting plate 46 along the height direction of the lens holder 42 on both sides in the width direction thereof, and then four suspension wires 48 are provided in total.

In addition, in the embodiment, between the lens holder 42 and the supporting plate 46, the support block 44 is provided that is attached to the base 40.

The supporting plate 46 is supported by the support block 44.

The support block 44 has the width along the tracking direction and the height along the focusing direction.

On both sides of the support block 44 along the tracking direction, two suspension wire insertion parts 4402 are spaced in the focusing direction, and then four suspension wire insertion parts 4402 are provided in total.

In the embodiment, among the four suspension wire insertion parts 4402, the two suspension wire insertion parts 4402 positioned above are opened upward, and among the four suspension wire insertion parts 4402, the two suspension wire insertion parts 4402 positioned below are opened downward.

The supporting plate 46 is configured to include plate members 50 with flexibility, and a damping member 52 attached to the plate members 50.

The supporting plate 46 has the width along the tracking direction and the height along the focusing direction. In the supporting plate 46, a center part 46A in the width direction is supported by (attached to) a mounting part 4410 at the center in the width direction of the support block 44, and two side parts 46B are flexible in the thickness direction except the center part 46A.

In the embodiment, two plate members 50 are provided and the damping member 52 has a plate shape, in which the supporting plate 46 is configured of the two plate members 50 clamping the damping member 52.

Therefore, the supporting plate 46 has a rigidity of the two plate members 50.

For the two plate members 50, various materials known before such as synthetic resins or metals can be used. In the embodiment, the plate member 50 is configured of a printed circuit board. For the printed circuit board, various materials known before such as a glass epoxy substrate or a substrate using a polyimide film can be used.

For the damping member 52, various materials known before for damping vibrations can be used. For example, a silicon gel, a pressure sensitive adhesive double coated tape, and an adhesive with flexibility can be used.

In addition, the contacting areas of the plate members 50 contacted with the damping member 52 may be bonded, or not. It is sufficient that the damping member 52 can be deformed in the direction of extending the plate members 50 as it follows the bend of the plate members 50 when the plate members 50 are bent. In addition, the shape of the damping member 52 is not restricted to a plate shape, and various shapes known before can be adapted.

In the embodiment, each of the suspension wires 48 is arranged as it is inserted into the suspension wire insertion part 4402. The tip end of the suspension wire 48 is attached to a mounting part 4202 provided on both sides of the lens holder 42 in the width direction, and the rear end of the suspension wire 48 is attached to the two side parts 46B of the supporting plate 46.

In the embodiment, the rear end of the suspension wire 48 is soldered to the land of at least one of the printed circuit boards configuring the plate members 50, whereby the rear end of the suspension wire 48 and the supporting plate 46 are mechanically attached to each other as well as electrically connected to each other.

The printed circuit board has a function that supplies a focus drive signal and a tracking drive signal provided from the servo control part 20 (FIG. 1) to the focusing coil 56 and the tracking coil 58, described below, through the suspension wire 48.

In addition, such a scheme may be possible in which a lead wire is directly and electrically connected to the suspension wire 48 and the drive signals provided from the servo control part 20 are supplied to the focusing coil 56 and the tracking coil 58 through the lead wire. In this case, for the plate member 50, materials other than that of the printed circuit board can be used.

The focusing coil 56 and the tracking coil 58 are provided on both sides of the lens holder 42 in the length direction, to which the tip end of the suspension wires 48 is electrically connected.

The yoke plate 62 is provided on the base 40 facing the lens holder 42, and an erecting part 6202 is erected on both sides of the yoke plate 62 in the tangential direction in such a way that the lens holder 42 is in between in the tangential direction.

The magnet 60 is attached at the place at which each of the erecting parts 6202 faces the focusing coil 56 and the tracking coil 58, whereby a magnetic circuit formed of the magnets 60 and the yoke plate 62 is provided.

In addition, on the yoke plate 62 and the base 40, an opening, not shown, is formed that secures an optical path passing through the first and second objective lenses 38A and 38B.

In the state in which the focus drive signal is not supplied to the focusing coil 56, the lens holder 42 is held at the neutral position in the focusing direction with the elasticity of the suspension wire 48. In addition, in the state in which the tracking drive signal is not supplied to the tracking coil 58, the lens holder 42 is held at the neutral position in the tracking direction with the elasticity of the suspension wire 48.

In addition, in the state in which the supporting plate 46 is not bent, the lens holder 42 is held at the neutral position in the tangential direction.

The servo control part 20 supplies the focus drive signal to the focusing coil 56, and then the force in the focusing direction caused by the magnetic interaction between the magnetic field generated in the focusing coil 56 and the magnetic field in each of the magnets 60 acts upon the lens holder 42 against the restoring force that is returning the lens holder 42 to the neutral position in the focusing direction by each of the suspension wires 48, whereby the lens holder 42 is moved in the focusing direction.

In addition, the servo control part 20 supplies the tracking drive signal to the tracking coil 58, and then the force in the tracking direction caused by the magnetic interaction between the magnetic field generated in the tracking coil 58 and the magnetic field in each of the magnets 60 acts upon the lens holder 42 against the restoring force that is returning the lens holder 42 to the neutral position in the tracking direction by each of the suspension wires 48, whereby the lens holder 42 is moved in the tracking direction.

In the embodiment, a first actuator that moves lens holder 42 in the focusing direction is configured of the focusing coils 56, the magnets 60, and the yoke plate 62, and a second actuator that moves the lens holder 42 in the tracking direction is configured of the tracking coils 58, the magnets 60, and the yoke plate 62.

In addition, it is configured in which a gel 54 is filled in the suspension wire insertion part 4402 into which the suspension wire 48 is inserted, and when the suspension wire 48 is bent in the direction intersecting its longitudinal direction, the gel 54 is deformed to absorb the vibrations of the lens holder 42 in the direction intersecting the longitudinal direction of the suspension wire 48.

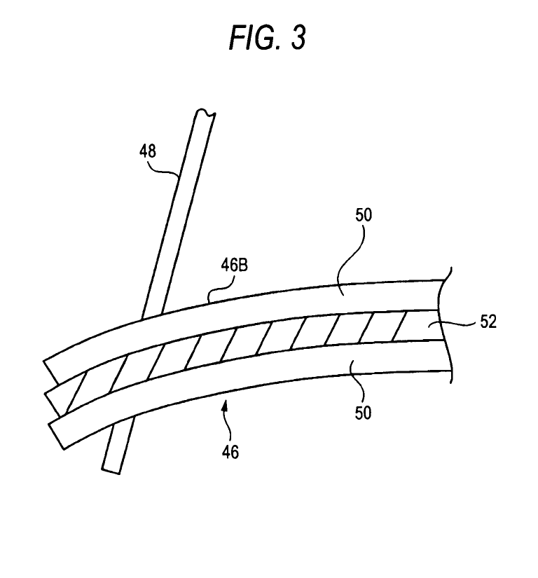

Then, as shown in FIG. 3, it is configured in which when the two side parts 46B of the supporting plate 46 are bent in the longitudinal direction of the suspension wire 48, the damping member 52 is deformed to absorb the vibrations of the lens holder 42 transmitted through the suspension wire 48. In addition, in the embodiment, the deformation of the supporting plate 46 is the deformation in the arc direction around the center part 46A as indicated by an arrow A in FIG. 2A, or the deformation in the arc direction about around the center part 46A as indicated by arrows B in FIG. 2B. Moreover, since two suspension wires 48 are spaced in the focusing direction, it is the deformation along both ends of the tracking direction of the supporting plate 46 and along the tangential direction of both ends in the focusing direction, and when these components are deformed, the damping member 52 is deformed as it follows the supporting plate 46 to absorb the vibrations of the lens holder 42.

According to the embodiment, the supporting plate 46 supports the suspension wire 48, the supporting plate 46 is configured of the plate members 50 with flexibility, and the damping member 52 is provided on the plate members 50. Thus, the vibrations of the lens holder 42 transmitted through the suspension wire 48 which are generated when the lens holder 42 is moved in the focusing direction and in the tracking direction are absorbed by the damping member 52. Therefore, the generation of undesired resonance of the lens holder 42 can be effectively suppressed, which advantageously intends to stabilize servo control as well as advantageously intends to increase the number of revolutions of an optical disk and to improve recording density of an optical disk.

Particularly, as in the embodiment, in the configuration in which a plurality of the objective lenses 38A and 38B is assembled in the lens holder 42, the distance between the optical axis of each of the objective lenses 38A and 38B and the center of vibrations of the lens holder 42 tends to increase, which leads to a greater problem caused by an influence of undesired resonance that occurs in the lens holder 42 on the optical characteristics of the optical pickup 14. However, in the embodiment, since the generation of undesired resonance of the lens holder 42 can be effectively suppressed, it is advantageously intended to stabilize servo control in the case in which the optical pickup 14 with a plurality of objective lenses like this is used.

In addition, in the embodiment, since the gel 54 is filled in the suspension wire insertion part 4402 of the support block 44 into which the suspension wire 48 is inserted, the gel 54 absorbs the vibrations of the lens holder 42 along the direction intersecting the longitudinal direction of the suspension wire 48 which occur when the lens holder 42 is moved in the focusing direction and in the tracking direction. Therefore, the generation of undesired resonance of the lens holder 42 can be suppressed more effectively, which further advantageously intends to stabilize servo control.

### Second Embodiment

Next, a second embodiment will be described.

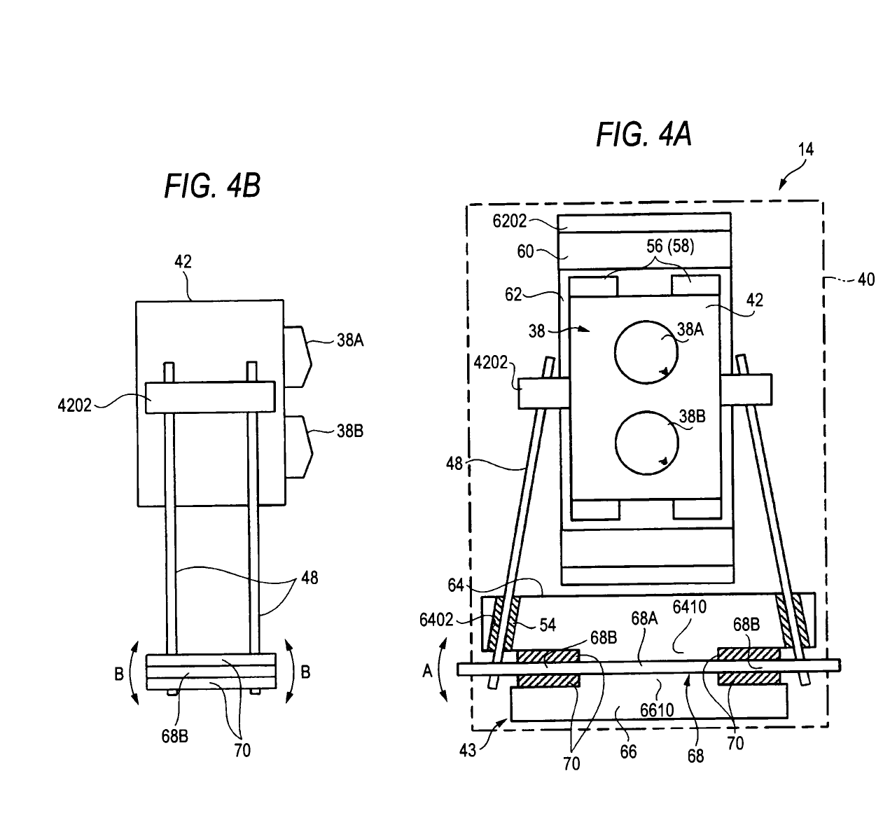

FIG. 4A shows a plan view depicting the configuration of an optical pickup 14 according to the second embodiment, and FIG. 4B shows a side view depicting the essential part of FIG. 4A.

In addition, in the embodiment below, the same members and places as those in the first embodiment are designated the same numerals and signs, omitting the descriptions.

As shown in FIG. 4A, the optical pickup 14 has a base 40, a lens holder 42, and a support mechanism 43 of the lens holder 42. In the second embodiment, the support mechanism 43 is configured to include first and second support blocks 64 and 66, a supporting plate 68, and a plurality of suspension wires 48.

The supporting plate 68 is provided on the base 40 and spaced from the lens holder 42 in the direction orthogonal to the focusing direction, and the supporting plate 68 is in parallel with the plane including the focusing direction and the tracking direction.

Then, the suspension wire 48 is provided over the lens holder 42 and the supporting plate 68, and movably supports the lens holder 42 in the focusing direction and the tracking direction with respect to the supporting plate 68.

The first support block 64 and the second support block 66 are erected from the base 40 so as to face both sides of the supporting plate 68 along the direction orthogonal to the focusing direction.

The first support block 64 and the second support block 66 has the width along the tracking direction and the height along the focusing direction. The first support block 64 is positioned between the lens holder 42 and the supporting plate 68, and on both sides of the first support block 64 along the tracking direction, two suspension wire insertion parts 6402 are spaced in the focusing direction, and then four suspension wire insertion parts 6402 are provided in total.

In addition, at the center part in the width direction on the plane on which the first support block 64 faces the supporting plate 68, a mounting part 6410 is protruded.

The second support block 66 is positioned at the place on the supporting plate 68 positioned opposite to the first support block 64, and at the center part in the width direction on the plane on which the second support block 66 faces the supporting plate 68, a mounting part 6610 is protruded.

In the embodiment, among the four suspension wire insertion parts 6402, the two suspension wire insertion parts 6402 positioned above are opened upward, and among the four suspension wire insertion parts 6402, the two suspension wire insertion parts 6402 positioned below are opened downward.

The supporting plate 68 is configured of a material with flexibility.

The supporting plate 68 has the width along the tracking direction and the height along the focusing direction. In the supporting plate 68, a center part 68A in the width direction is clamped between a mounting part 6410 of the first support block 64 and a mounting part 6610 of the second support block 66, and two side parts 68B are flexible in the thickness direction except the center part 68A.

Furthermore, the supporting plate 68 is clamped between damping members 70 provided on both sides of the center part in the tracking direction, each of which is provided between the supporting plate 68 and the first support block 64 and between the supporting plate 68 and the second support block 66.

Each of the damping members 70 has a plate shape, and extended in the direction in parallel with the focusing direction.

For the supporting plate 68, various materials known before such as synthetic resins or metals can be used. In the embodiment, the supporting plate 68 is configured of a printed circuit board similar to that in the first embodiment.

For the damping member 70, various materials known before can be used for damping vibrations. For example, a silicon gel, a pressure sensitive adhesive double coated tape, and an adhesive with flexibility can be used.

In addition, the contacting areas of the supporting plate 68 contacted with the damping member 70 may be bonded or not. It is sufficient that the damping member 70 can be deformed as it follows the bend of the supporting plate 68 when the supporting plate 68 is bent. In addition, the shape of the damping member 70 is not restricted to a plate shape, various shapes known before can be adapted.

Each of the suspension wires 48 is arranged as it is inserted into the suspension wire insertion part 6402, the tip end of the suspension wire 48 is attached to a mounting part 4202 protruded on both sides of the lens holder 42 in the width direction, and the rear end of the suspension wire 48 is attached to the two side parts 68B of the supporting plate 68.

In addition, as similar to the first embodiment, the suspension wire 48 is provided from the lens holder 42 to the supporting plate 46 along the height direction of the lens holder 42 on both sides in the width direction thereof, and then four suspension wires 48 are provided in total.

Therefore, the suspension wire 48 is provided on both sides of the lens holder 42 in the width direction and both sides of the supporting plate 68 in the tracking direction.

In the embodiment, the rear end of the suspension wire 48 is soldered to the land of the printed circuit board configuring the supporting plate 68, whereby the rear end of the suspension wire 48 and the supporting plate 68 are mechanically attached to each other as well as electrically connected to each other.

The printed circuit board has a function that supplies the focus drive signal and the tracking drive signal provided from the servo control part 20 (FIG. 1) to the focusing coil 56 and the tracking coil 58 through the suspension wire 48.

In addition, as similar to the first embodiment, it is configured in which a gel 54 is filled in the suspension wire insertion part 6402 into which the suspension wire 48 is inserted, and when the suspension wire 48 is bent in the direction intersecting its longitudinal direction, the gel 54 is deformed to absorb the vibrations of the lens holder 42 in the direction intersecting the longitudinal direction of the suspension wire 48.

Then, it is configured in which when the two side parts 68B of the supporting plate 68 are bent in the longitudinal direction of the suspension wire 48, the damping member 70 is deformed to absorb the vibrations of the lens holder 42 transmitted through the suspension wire 48. In addition, in the embodiment, the deformation of the supporting plate 68 is the deformation in the arc direction around the mounting parts 6410 and 6610 as indicated by an arrow A in FIG. 4A, or it is the deformation in the arc direction about around the mounting parts 6410 and 6610 as indicated by arrows B in FIG. 4B. In addition, since two suspension wires 48 are spaced in the focusing direction, it is the deformation along both ends of the tracking direction of the supporting plate 68 and both ends of the focusing direction in the tangential direction, and when these components are deformed, the damping member 70 is deformed as it follows the supporting plate 68 to absorb the vibrations of the lens holder 42.

According to the second embodiment, it is configured in which the supporting plate 68 configured of a material with flexibility is clamped between the damping members 70, each of which is provided between the supporting plate 68 and the first support block 64 and between the supporting plate 68 and the second support block 66. Thus, the damping member 70 absorbs the vibrations of the lens holder 42 transmitted through the suspension wire 48 which are generated when the lens holder 42 is moved in the focusing direction and in the tracking direction. Therefore, the generation of undesired resonance of the lens holder 42 can be effectively suppressed, which advantageously intends to stabilize servo control as well as advantageously intends to increase the number of revolutions of an optical disk and to improve recording density of an optical disk.

Particularly, in the configuration in which a plurality of the objective lenses 38A and 38B is assembled in the lens holder 42, the distance between the optical axis of each of the objective lenses 38A and 38B and the center of vibrations of the lens holder 42 tends to increase, which leads to a greater problem caused by an influence of undesired resonance that occurs in the lens holder 42 on the optical characteristics of the optical pickup 14. However, according to the second embodiment, since the generation of undesired resonance of the lens holder 42 can be effectively suppressed, it is advantageously intended to stabilize servo control in the case in which the optical pickup 14 with a plurality of objective lenses like this is used.

In addition, as similar to the first embodiment, also in the second embodiment, since the gel 54 is filled in the suspension wire insertion part 6402 of the support block 44 into which the suspension wire 48 is inserted, the gel 54 absorbs the vibrations of the lens holder 42 along the direction intersecting the longitudinal direction of the suspension wire 48 which occur when the lens holder 42 is moved in the focusing direction and in the tracking direction. Therefore, the generation of undesired resonance of the lens holder 42 can be suppressed more effectively, which further advantageously intends to stabilize servo control.

### Third Embodiment

Next, a third embodiment will be described.

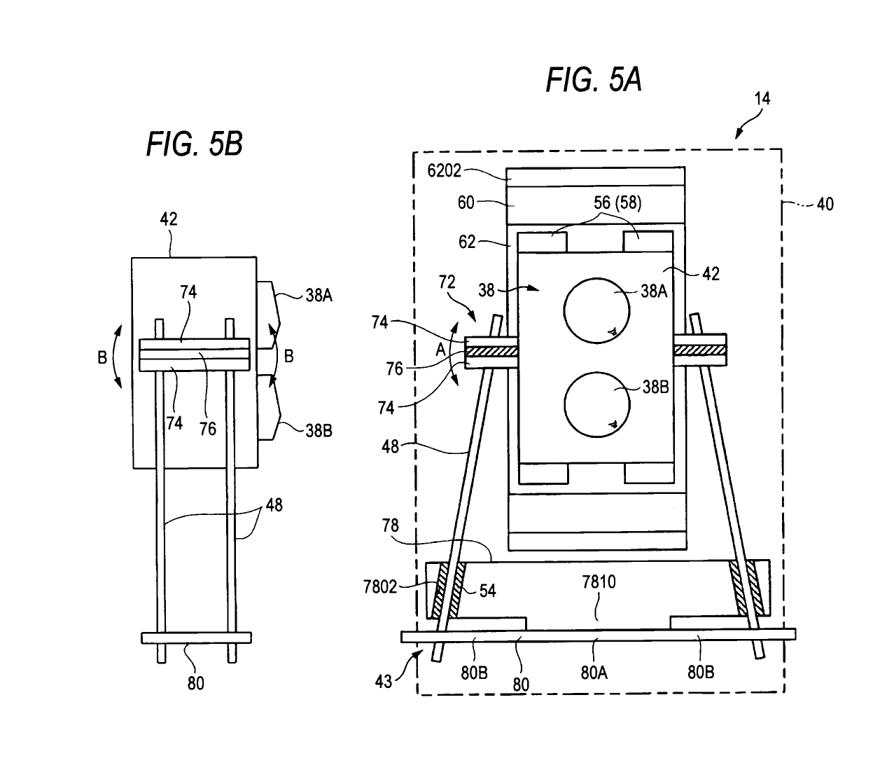

FIG. 5A shows a plan view depicting the configuration of an optical pickup 14 according to the third embodiment, and FIG. 5B shows a side view depicting the essential part of FIG. 5A.

As shown in FIG. 5A, the optical pickup 14 has a base 40, a lens holder 42, and a support mechanism 43 of the lens holder 42. In the third embodiment, the support mechanism 43 is configured to include suspension wires 48 that movably support the lens holder 42 in the focusing direction and the tracking direction on the base 40, mounting plates 74 with flexibility that are provided on the lens holder 42 in parallel with the plane including the focusing direction and the tracking direction and coupled with the end part of the suspension wire 48, a damping member 76, a support block 78 that is provided on the base 40, and a supporting plate 80.

The supporting plate 80 is provided on the base 40 and spaced from the lens holder 42 in the direction orthogonal to the focusing direction, and the supporting plate 80 is in parallel with the plane including the focusing direction and the tracking direction.

Then, the suspension wire 48 is provided over the lens holder 42 and the supporting plate 80, and movably supports the lens holder 42 in the focusing direction and the tracking direction with respect to the supporting plate 80.

The support block 78 is erected from the base 40 so as to face both ends of the supporting plate 80 along the direction orthogonal to the focusing direction.

The support block 78 has the width along the tracking direction and the height along the focusing direction.

The support block 78 is attached to the base 40 between the lens holder 42 and the supporting plate 80, and on both sides of the support block 78 along the tracking direction, two suspension wire insertion parts 7802 are spaced in the focusing direction, and then four suspension wire insertion parts 7802 are provided in total.

In addition, at the center part in the width direction on the plane on which the support block 78 faces the supporting plate 80, a mounting part 7810 is protruded.

The supporting plate 80 is configured of a material with flexibility.

The supporting plate 80 has the width along the tracking direction and the height along the focusing direction. In the supporting plate 80, a center part 80A in the width direction is supported by the mounting part 7810 of the support block 78, and two side parts 80B are flexible in the thickness direction except the center part 80A.

For the supporting plate 80, various materials known before such as synthetic resins or metals can be used. In the embodiment, the supporting plate 80 is configured of a printed circuit board similar to that in the first embodiment.

Each of the suspension wires 48 is arranged as it is inserted into the suspension wire insertion part 7802, the tip end of the suspension wire 48 is attached to the lens holder 42 through a coupling part 72, described below, and the rear end of the suspension wire 48 is attached to the two side parts 68B of the supporting plate 68.

In addition, as similar to the first embodiment, the suspension wire 48 is provided from the lens holder 42 to the supporting plate 46 along the height direction of the lens holder 42 on both sides in the width direction thereof, and then four suspension wires 48 are provided in total.

In the embodiment, the rear end of the suspension wire 48 is soldered to the land of the printed circuit board configuring the supporting plate 80, whereby the rear end of the suspension wire 48 and the supporting plate 80 are mechanically attached to each other as well as electrically connected to each other.

The printed circuit board has a function that supplies the focus drive signal and the tracking drive signal provided from the servo control part 20 (FIG. 1) to the focusing coil 56 and the tracking coil 58 through the suspension wire 48.

The coupling part 72 is provided on each of two side parts of the lens holder 42 in the tracking direction.

The coupling part 72 is configured to include two mounting plates 74 and a damping member 76.

The mounting plates 74 having flexibility are provided on the lens holder 42 and spaced in the direction orthogonal to the focusing direction in parallel with the plane including the focusing direction and the tracking direction.

In the embodiment, the tip end of the suspension wire 48 is attached to at least one of the mounting plates 74.

For the mounting plate 74, various materials known before such as synthetic resins or metals can be used.

In addition, the mounting plates 74 may be provided in one piece with the lens holder 42, or may be separately provided from the lens holder 42 and attached to the lens holder 42.

The damping member 76 is clamped between the two mounting plates 74.

For the damping member 76, various materials known before can be used for damping vibrations. For example, a silicon gel, a pressure sensitive adhesive double coated tape or an adhesive with flexibility can be used.

In addition, the contacting areas of the mounting plates 74 contacted with the damping member 76 may be bonded or not. It is sufficient that the damping member 76 can be deformed as it follows the bend of the mounting plates 74 when the mounting plates 74 are bent. In addition, the shape of the damping member 76 is not restricted to a plate shape, various shapes known before can be adapted.

In addition, as similar to the first embodiment, it is configured in which the gel 54 is filled in the suspension wire insertion part 7802 into which the suspension wire 48 is inserted, and when the suspension wire 48 is bent in the direction intersecting its longitudinal direction, the gel 54 is deformed to absorb the vibrations of the lens holder 42 in the direction intersecting the longitudinal direction of the suspension wire 48.

Then, it is configured in which when the mounting plates 74 are bent in the longitudinal direction of the suspension wire 48, the damping member 76 is deformed to absorb the vibrations of the lens holder 42. In addition, in the embodiment, the deformation of the mounting plates 74 is the deformation in the arc direction around the place at which the mounting plates 74 are connected to the lens holder 42 as indicated by an arrow A in FIG. 5A, or, it is the deformation in the arc direction as indicated by arrows B in FIG. 5B. In addition, since two suspension wires 48 are spaced in the focusing direction, it is the deformation along the tangential direction of both ends of the focusing direction of the mounting plates 74, and when these components are deformed, the damping member 76 is deformed as it follows the mounting plates 74 to absorb the vibrations of the lens holder 42.

According to the third embodiment, the lens holder 42 is provided with the mounting plates 74 to which the end part of the suspension wire 48 is coupled, the mounting plates 74 are provided with flexibility, and the damping member 76 is provided on the mounting plates 74. Thus, the damping member 76 absorbs the vibrations of the lens holder 42 that occur when the lens holder 42 is moved in the focusing direction and in the tracking direction. Therefore, the generation of undesired resonance of the lens holder 42 can be effectively suppressed, which advantageously intends to stabilize servo control as well as advantageously intends to increase the number of revolutions of an optical disk and to improve recording density of an optical disk.

Particularly, in the configuration in which a plurality of the objective lenses 38A and 38B is assembled in the lens holder 42, the distance between the optical axis of each of the objective lenses 38A and 38B and the center of vibrations of the lens holder 42 tends to increase, which leads to a greater problem caused by an influence of undesired resonance that occurs in the lens holder 42 on the optical characteristics of the optical pickup 14. However, according to the third embodiment, since the generation of undesired resonance of the lens holder 42 can be effectively suppressed, it is advantageously intended to stabilize servo control in the case in which the optical pickup 14 with a plurality of objective lenses like this is used.

In addition, as similar to the first embodiment, also in the third embodiment, since the gel 54 is filled in the suspension wire insertion part 7802 of the support block 78 into which the suspension wire 48 is inserted, the gel 54 absorbs the vibrations of the lens holder 42 along the direction intersecting the longitudinal direction of the suspension wire 48 which occur when the lens holder 42 is moved in the focusing direction and in the tracking direction. Therefore, the generation of undesired resonance of the lens holder 42 can be suppressed more effectively, which further advantageously intends to stabilize servo control.

### Fourth Embodiment

Next, a fourth embodiment will be described.

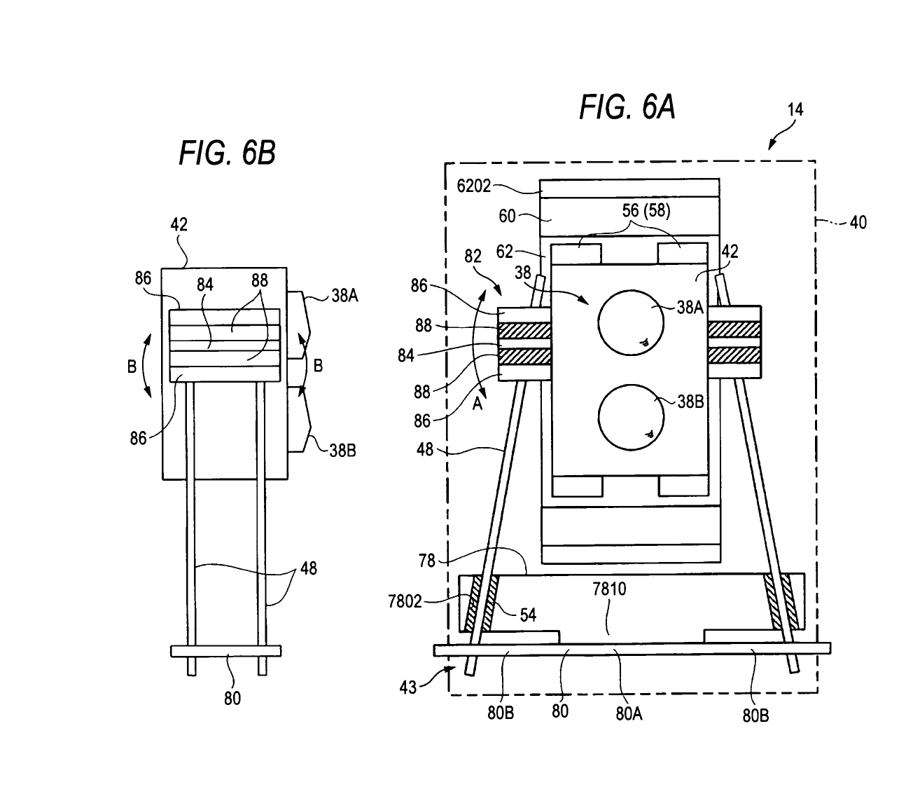

FIG. 6A shows a plan view depicting the configuration of an optical pickup 14 according to the fourth embodiment, and FIG. 6B shows a side view depicting the essential part of FIG. 6A.

As shown in FIG. 6A, the optical pickup 14 has a base 40, a lens holder 42, and a support mechanism 43 of the lens holder 42.

In the fourth embodiment, the support mechanism 43 is configured to include suspension wires 48 that movably support the lens holder 42 in the focusing direction and the tracking direction on the base 40, a mounting plate 84 that is provided on the lens holder 42 in parallel with the plane including the focusing direction and the tracking direction with flexibility and is coupled to the end part of the suspension wire 48, fixing plates 86 that are provided on the lens holder 42, damping members 88, a support block 78 that is provided on the base 40, and a supporting plate 80.

The configurations of the support block 78 and the supporting plate 80 are the same as those in the third embodiment. Each of the suspension wires 48 is arranged as it is inserted into the suspension wire insertion part 7802, the tip end of the suspension wire 48 is attached to the lens holder 42 through a coupling part 82, described below, and the rear end of the suspension wire 48 is attached to two side parts 80B of the supporting plate 80.

In addition, as similar to the first embodiment, the suspension wire 48 is provided from the lens holder 42 to the supporting plate 46 along the height direction of the lens holder 42 on both sides in the width direction thereof, and then four suspension wires 48 are provided in total.

Moreover, as similar to the third embodiment, the rear end of the suspension wire 48 is soldered to the land of the printed circuit board configuring the supporting plate 80, whereby the rear end of the suspension wire 48 and the supporting plate 80 are mechanically attached to each other as well as electrically connected to each other.

Then, by the printed circuit board, the focus drive signal and the tracking drive signal provided from the servo control part 20 (FIG. 1) are supplied to the focusing coil 56 and the tracking coil 58 through the suspension wire 48.

The coupling part 82 is provided on each of two side parts of the lens holder 42 in the tracking direction.

The coupling part 82 is configured to include a single mounting plate 84, two fixing plates 86, and two damping members 88.

The mounting plate 84 is provided on the lens holder 42 in parallel with the plane including the focusing direction and the tracking direction, having flexibility.

For the mounting plate 84, various materials known before such as synthetic resins or metals can be used.

In addition, the mounting plate 84 may be provided in one piece with the lens holder 42, or may be separately provided from the lens holder 42 and attached to the lens holder 42.

The two fixing plates 86 having rigidity are provided on both sides of the mounting plate 84 on the lens holder 42 in the tangential direction.

In addition, the two fixing plates 86 may be provided in one piece with the lens holder 42, or may be separately provided from the lens holder 42 and attached to the lens holder 42.

The damping member 88 has a plate shape, and clamped between the fixing plate 86 and the mounting plate 84 on both sides.

For the damping member 88, various materials known before can be used for damping vibrations. For example, a silicon gel, a pressure sensitive adhesive double coated tape, and an adhesive with flexibility can be used.

In addition, the contacting areas of the mounting plate 84 contacted with the damping member 88 may be bonded or not. It is sufficient that when the mounting plate 84 is bent, the damping members 88 can be deformed as they follow the bend of the mounting plate 84. In addition, the shape of the damping member 88 is not restricted to a plate shape, various shapes known before can be adapted.

The tip end of the suspension wire 48 is attached to the mounting plate 84.

In the embodiment, the two fixing plates 86 are formed with through holes, not shown, having a cross section greater than the cross section of the suspension wire 48, and the portion of the suspension wire 48 before and after the places at which the suspension wire 48 is attached to the mounting plate 84 is inserted into the through hole.

In addition, as similar to the third embodiment, it is configured in which the gel 54 is filled in the suspension wire insertion part 7802 into which the suspension wire 48 is inserted, and when the suspension wire 48 is bent in the direction intersecting its longitudinal direction, the gel 54 is deformed to absorb the vibrations of the lens holder 42 in the direction intersecting the longitudinal direction of the suspension wire 48.

Then, it is configured in which when the mounting plate 84 is bent in the longitudinal direction of the suspension wire 48, the damping members 88 are deformed to absorb the vibrations of the lens holder 42. In addition, in the embodiment, the deformation of the mounting plate 84 is the deformation in the arc direction around the place at which the mounting plate 84 is connected to the lens holder 42 as indicated by an arrow A in FIG. 6A, or it is the deformation in the arc direction as indicated by arrows B in FIG. 6B. In addition, since two suspension wires 48 are spaced in the focusing direction, it is the deformation along the tangential direction of both ends of the focusing direction of the mounting plate 84, and when these components are deformed, the damping members 88 are deformed as they follow the mounting plate 84 to absorb the vibrations of the lens holder 42.

According to the fourth embodiment, the lens holder 42 is provided with the mounting plate 84 to which the end part of the suspension wire 48 is coupled, the mounting plate 84 is provided with flexibility, and the damping members 88 are provided on the mounting plate 84. Thus, the damping members 88 absorb the vibrations of the lens holder 42 that occur when the lens holder 42 is moved in the focusing direction and in the tracking direction. Therefore, the generation of undesired resonance of the lens holder 42 can be effectively suppressed, which advantageously intends to stabilize servo control as well as advantageously intends to increase the number of revolutions of an optical disk and to improve recording density of an optical disk.

Particularly, in the configuration in which a plurality of the objective lenses 38A and 38B is assembled in the lens holder 42, the distance between the optical axis of each of the objective lenses 38A and 38B and the center of vibrations of the lens holder 42 tends to increase, which leads to a greater problem caused by an influence of undesired resonance that occurs in the lens holder 42 on the optical characteristics of the optical pickup 14. However, according to the fourth embodiment, since the generation of undesired resonance of the lens holder 42 can be effectively suppressed, it is advantageously intended to stabilize servo control in the case in which the optical pickup 14 with a plurality of objective lenses like this is used.

In addition, as similar to the first embodiment, also in the fourth embodiment, since the gel 54 is filled in the suspension wire insertion part 7802 of the support block 78 into which the suspension wire 48 is inserted, the gel 54 absorbs the vibrations of the lens holder 42 along the direction intersecting the longitudinal direction of the suspension wire 48 which occur when the lens holder 42 is moved in the focusing direction and in the tracking direction. Therefore, the generation of undesired resonance of the lens holder 42 can be suppressed more effectively, which further advantageously intends to stabilize servo control.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup comprising:
a base;
a lens holder that is provided on the base to hold an objective lens which collects a light beam emitted from a light source and applies it onto an optical disk;
a supporting plate that is provided on the base and spaced from the lens holder in a direction orthogonal to a focusing direction in parallel with a plane including the focusing direction and a tracking direction; and
a plurality of suspension wires that is provided over the lens holder and the supporting plate to movably support the lens holder in the focusing direction and the tracking direction with respect to the supporting plate,
wherein the supporting plate has flexibility,
a damping member is provided on the mounting plate, and
when the supporting plate is bent in the longitudinal direction of the suspension wire, the damping member is deformed to absorb vibrations of the lens holder.

2. The optical pickup according to claim 1,
wherein a plurality of the supporting plates is provided and spaced in the direction orthogonal to the focusing direction, and
the damping member is clamped between the plurality of the supporting plates.

3. The optical pickup according to claim 1,
wherein between the lens holder and the supporting plate, a support block is provided that is attached on the base and has a suspension wire insertion part,
the supporting plate is supported by the support block,
the suspension wire is inserted into the suspension wire insertion part,
a gel is filled in the suspension wire insertion part, and
when the suspension wire is bent in a direction intersecting its longitudinal direction, the gel is deformed to absorb vibrations of the lens holder along a direction intersecting the longitudinal direction of the suspension wire.

4. The optical pickup according to claim 2, comprising:
an actuator that moves the lens holder in the focusing direction and in the tracking direction,
wherein the suspension wire has conductivity,
the supporting plate is configured of two printed circuit boards spaced in the direction orthogonal to the focusing direction,
the damping member is clamped between the two printed circuit boards, and
both ends of the suspension wire in the length direction are electrically connected to the printed circuit board and to the actuator.

5. The optical pickup according to claim 1,
wherein the lens holder has a length along the longitudinal direction of the suspension wire and a width in a direction orthogonal to the length,
the suspension wire is provided between both sides of the lens holder in the width direction and both sides of the supporting plate in the tracking direction,
a first support block and a second support block are erected from the base so as to face both sides of the supporting plate along a direction orthogonal to the focusing direction,
a center part of the supporting plate in tracking direction is clamped between the first support block and the second support block, and
on both sides of the center part of the supporting plate, the damping member is provided between the supporting plate and the first support block and between the supporting plate and the second support block to clamp the supporting plate.

6. The optical pickup according to claim 5,
wherein the first support block is positioned between the lens holder and the supporting plate,
the first support block has a suspension wire insertion part, and
the suspension wire is inserted into the suspension wire insertion part.

7. The optical pickup according to claim 5, comprising:
an actuator that moves the lens holder in the focusing direction and in the tracking direction,
wherein the suspension wire has conductivity,
the supporting plate is configured of a printed circuit board, and
both ends of the suspension wire in the length direction are electrically connected to the printed circuit board and to the actuator.

8. An optical pickup comprising:
a base;
a lens holder that is provided on the base to hold an objective lens which collects a light beam emitted from a light source and applies it onto an optical disk; and
a support mechanism that supports the lens holder, in which the support mechanism is configured to include a suspension wire that movably supports the lens holder on the base in a focusing direction and a tracking direction,
wherein the lens holder is provided with a mounting plate with flexibility which is in parallel with a plane including the focusing direction and the tracking direction and to which an end part of the suspension wire is coupled,
a damping member is provided on the mounting plate, and
when the mounting plate is bent in the longitudinal direction of the suspension wire, the damping member is deformed to absorb vibrations of the lens holder.

9. The optical pickup according to claim 8,
wherein two mounting plates are provided and spaced in the direction orthogonal to the focusing direction, and
the damping member is clamped between the two mounting plates.

10. The optical pickup according to claim 8,
wherein at a place on the base spaced from the lens holder in the direction orthogonal to the focusing direction, a supporting plate is provided that is in parallel with a plane including the focusing direction and the tracking direction with flexibility, and
the suspension wire is provided over the mounting plate and the supporting plate.

11. The optical pickup according to claim 8,
wherein at a place on the base spaced from the lens holder in the direction orthogonal to the focusing direction, a supporting plate is provided that is in parallel with a plane including the focusing direction and the tracking direction with flexibility,
between the lens holder and the supporting plate, a support block is provided that is attached on the base hand has a suspension wire insertion part,
the supporting plate is supported by the support block, and
the suspension wire is inserted into the suspension wire insertion part over the mounting plate and the supporting plate.

12. The optical pickup according to claim 8,
wherein a fixing plate is provided at a place on the lens holder on both sides of the mounting plate in a tangential direction, and
the damping member is clamped between the fixing plate and the mounting plate on both sides.

13. The optical pickup according to claim 8,
wherein at a place on the base spaced from the lens holder in the direction orthogonal to the focusing direction, a supporting plate is provided that is in parallel with a plane including the focusing direction and the tracking direction with flexibility, and
the suspension wire is provided over the mounting plate and the supporting plate.

14. The optical pickup according to claim 8,
wherein at a place on the base spaced from the lens holder in the direction orthogonal to the focusing direction, a supporting plate is provided that is in parallel with a plane including the focusing direction and the tracking direction with flexibility,
between the lens holder and the supporting plate, a support block is provided that is attached on the base hand has a suspension wire insertion part,
the supporting plate is supported by the support block, and
the suspension wire is inserted into the suspension wire insertion part over the mounting plate and the supporting plate.

15. The optical pickup according to claim 8,
wherein at a place on the base spaced from the lens holder in the direction orthogonal to the focusing direction, a supporting plate is provided that is in parallel with a plane including the focusing direction and the tracking direction with flexibility,
the suspension wire is provided over the mounting plate and the supporting plate,
an actuator is provided that moves the lens holder in the focusing direction and in the tracking direction,
the suspension wire has conductivity,
the supporting plate is configured of a printed circuit board, and
both ends of the suspension wire in the length direction are electrically connected to the printed circuit board and to the actuator.

16. An optical pickup comprising:
a base;
a lens holder that is provided on the base to hold an objective lens which collects a light beam emitted from a light source and applies it onto an optical disk; and
a support mechanism for the lens holder, in which the support mechanism is configured to include a suspension wire that movably supports the lens holder on the base in a focusing direction and a tracking direction,
wherein the support mechanism is configured to include a damping member that absorbs vibrations of the lens holder along the longitudinal direction of the suspension wire.

17. An optical disk apparatus comprising:
a drive unit configured to hold an optical disk to rotate and drive it; and
an optical pickup that applies a light beam for recording and/or reproducing onto the optical disk rotated and driven by the drive unit, and detects a light beam reflected from the optical disk,
wherein the optical pickup includes:
a base that is moved in a tracking direction of the optical disk,
a lens holder that is provided on the base to hold an objective lens which collects a light beam emitted from a light source and applies it onto the optical disk,
a supporting plate that is provided on the base and spaced from the lens holder in a direction orthogonal to a focusing direction in parallel with a plane including the focusing direction and the tracking direction, and
a plurality of suspension wires that is provided over the lens holder and the supporting plate to movably support the lens holder in the focusing direction and the tracking direction with respect to the supporting plate,
the supporting plate has flexibility,
a damping member is provided on the mounting plate, and
when the supporting plate is bent in the longitudinal direction of the suspension wire, the damping member is deformed to absorb vibrations of the lens holder.

18. An optical disk apparatus comprising:
a drive unit configured to hold an optical disk to rotate and drive it; and
an optical pickup that applies a light beam for recording and/or reproducing onto the optical disk rotated and driven by the drive unit, and detects a light beam reflected from the optical disk,
wherein the optical pickup includes:
a base that is moved in a tracking direction of the optical disk,
a lens holder that is provided on the base to hold an objective lens which collects a light beam emitted from a light source and applies it onto the optical disk, and
a support mechanism that supports the lens holder, in which the support mechanism is configured to include a suspension wire that movably supports the lens holder on the base in a focusing direction and the tracking direction,
the lens holder is provided with a mounting plate with flexibility which is in parallel with a plane including the focusing direction and the tracking direction and to which an end part of the suspension wire is coupled,
a damping member is provided on the mounting plate, and
when the mounting plate is bent in the longitudinal direction of the suspension wire, the damping member is deformed to absorb vibrations of the lens holder.

19. An optical disk apparatus comprising:
a drive unit configured to hold an optical disk to rotate and drive it; and
an optical pickup that applies a light beam for recording and/or reproducing onto the optical disk rotated and driven by the drive unit, and detects a light beam reflected from the optical disk,
wherein the optical pickup includes:
a base that is moved in a tracking direction of the optical disk,
a lens holder that is provided on the base to hold an objective lens which collects a light beam emitted from a light source and applies it onto the optical disk, and
a support mechanism for the lens holder,
the support mechanism is configured to include a suspension wire that movably supports the lens holder on the base in a focusing direction and the tracking direction, and
the support mechanism is configured to include a damping member that absorbs vibrations of the lens holder.
